(19) United States
(12) Patent Application Publication
(10) Pub. No.: US 2020/0293434 A1
(43) Pub. Date: Sep. 17, 2020

(54) TEST SELECTION DEVICE

(71) Applicant: NTT DOCOMO, INC., Chiyoda-ku, Tokyo (JP)

(72) Inventors: Shinya MASUDA, Chiyoda-ku (JP); Takashi YOSHIKAWA, Chiyoda-ku (JP); Koichi ASANO, Chiyoda-ku (JP)

(73) Assignee: NTT DOCOMO, INC., Chiyoda-ku, Tokyo (JP)

(21) Appl. No.: 16/083,977

(22) PCT Filed: Feb. 24, 2017
(86) PCT No.: PCT/JP2017/007124

§ 371 Date: Sep. 11, 2018

(30) Foreign Application Priority Data
May 19, 2016 (JP) 2016-100568

(51) Int. Cl. G06F 11/36; G06F 9/54

(52) U.S. Cl. CPC G06F 11/3688; G06F 11/3676; G06F 9/546; G06F 11/3684; G06F 11/3692

(57) ABSTRACT

An OS difference information acquisition unit 11 acquires difference information indicating information of a changed program in programs of an OS. A difference correspondence part identification unit 16 identifies a part corresponding to the difference information in an application program. A test selection unit 18 acquires test item information including a part which is executed in the application program in each test and selects a test in which the part of the application program included in the acquired test item information corresponds to the part identified by the difference correspondence part identification unit 16.

### TECHNICAL FIELD

The invention relates to a device that selects a test for a program.

### BACKGROUND ART

In the related art, techniques of identifying a part involved in a change in codes of a program are known. For example, Patent Literature 1 describes that a part involved in addition of a function is identified. Specifically, a set of differential codes between an old version before the addition of a function and a new version after the addition of a function and a set of source codes which have been subjected to a test case of executing only a specific function are identified, and a product set between the differential code set and the executed code set is calculated. Accordingly, codes which have been subjected to a test can be extracted from differential codes in the specific function.

### CITATION LIST

### Patent Literature

Patent Literature 1: Japanese Unexamined Patent Publication No. 2010-67188

### SUMMARY OF INVENTION

### Technical Problem

When correction of codes of a program is carried out after the program has been tested and all the tests which were executed before the correction has been carried out are executed, tests which are not involved in the correction of codes are executed, which is not efficient.

The invention is made in consideration of the above-mentioned circumstances and an objective thereof is to provide a test selection device that appropriately selects a test corresponding to an involved part of another program when correction of a program is carried out.

### Solution to Problem

A test selection device according to the invention includes: a difference acquisition means that acquires difference information indicating a changed part in a first program; a difference correspondence part identification means that identifies an involved part indicated by the difference information acquired by the difference acquisition means in a second program using functions based on the first program; and a test selection means that selects a test for the second program corresponding to the involved part identified by the difference correspondence part identification means.

In the test selection device according to the invention, since an involved part of the second program corresponding to the changed part in the first program is identified and a test for the involved part is selected, a test involved in a change of the first program can be selected. In this way, when correction of a program is carried out, it is possible to appropriately select a test.

The test selection device according to the invention may further include a test information acquisition means that acquires test information including an execution part which is executed in a test, and the test selection means may select a test corresponding to the involved part identified by the difference correspondence part identification means on the basis of the test information acquired by the test information acquisition means.

In the test selection device according to the invention, since a test is selected using information indicating an execution part of the test, it is possible to appropriately select a test involved in the difference information.

The test selection device according to the invention may further include a function identification means that identifies a function based on the difference information requiring authority for execution on the basis of the difference information acquired by the difference acquisition means, and the difference correspondence part identification means may identify an involved part of the second program corresponding to the function identified by the function identification means.

In the test selection device according to the invention, since a test corresponding to a function requiring authority for execution in the changed part of the first program is selected, it is possible to narrow a selection range to tests requiring authority and to select a test.

In the test selection device according to the invention, the test selection means may additionally select a test in which authority corresponding to the authority for the function identified by the function identification means is required for execution of the test.

In the test selection device according to the invention, since a test for the second program requiring authority which is required for execution of the changed first program is selected, it is possible to comprehensively select tests with authority involved in the change of the first program.

The test selection device according to the invention may further include an output means that outputs a message indicating that a test for the second program corresponding to the involved part has not been selected by the test selection means when the test for the second program has not been selected.

In the test selection device according to the invention, since there is an involved part but a message indicating that a test for the second program has not been selected is output, it is possible to notify that there is a likelihood that leakage of a test item will occur.

### Advantageous Effects of Invention

According to the invention, it is possible to appropriately select a test when correction of a program is carried out.

### BRIEF DESCRIPTION OF DRAWINGS

FIG. 1 is a block diagram illustrating a server according to an embodiment of the invention.

FIG. 2 is a diagram illustrating a hardware configuration of the server 10.

FIG. 3 is a diagram illustrating a data structure of information which is stored in an OS difference information storage unit 12.

FIG. 4 is a diagram illustrating a data structure of information which is stored in an authority-requiring API list storage unit 13.

FIG. 5 is a diagram illustrating a data structure of information which is stored in a source code storage unit 15.

FIG. 6 is a diagram illustrating an example of involved part information.

FIG. 7 is a diagram illustrating a data structure of information which is stored in a test item information storage unit 17.

FIG. 8 is a diagram illustrating an example in which a test is selected.

FIG. 9 is a diagram illustrating an example in which a test is selected.

FIG. 10 is a flowchart illustrating a test selection process.

### DESCRIPTION OF EMBODIMENTS

Hereinafter, an exemplary embodiment of the invention will be described in detail with reference to the accompanying drawings. In description with reference to the drawings, the same or corresponding elements will be referred to by the same reference signs and description thereof will not be repeated.

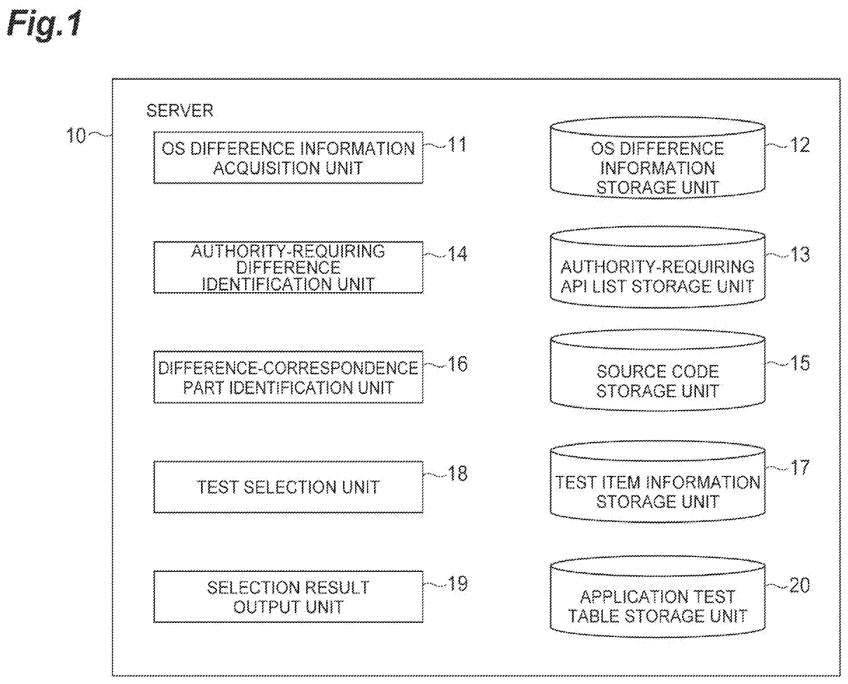

FIG. 1 illustrates a server 10 (a test selection device) according to the embodiment. When there are an OS (Operating System) program (a first program), which is a program of an OS and an application program (a second program) and correction of the OS program is carried out, the server 10 is a device that identifies a test of a part involved in the correction of the OS program from tests for the application program. An OS program is a type of software and is software in which functions of basically managing or controlling a device (for example, a mobile terminal), basic functions used commonly by many types of software, or the like are mounted and which manages a system as a whole. In an OS program, some programs of the OS program are changed. A version is set for an OS program, and a new version is set for a changed OS program when the OS program has been changed. There is a server device that stores source codes of the OS program, and the server device stores source codes of the OS program and also stores OS difference information including pre-change information and post-change information of the OS program. The OS difference information is information indicating a changed part in the OS program. An application program (an application) is a software program in which functions with the same purpose in software mounted in a device are collected as a single group. An application uses functions based on an OS program. A test is an operation of inspecting whether a target program operates according to requirements. A test of an application program is an operation of inspecting whether the application program can be executed according to requirements and is a test for executing the application program normally.

Functions of the server 10 according to this embodiment will be described in detail. The server 10 is connected to a server in which OS programs (a pre-change OS program and a post-change OS program) are stored via a network such as the Internet. As illustrated in FIG. 1, the server 10 includes an OS difference information acquisition unit 11 (difference acquisition means), an OS difference information storage unit 12, an authority-requiring API list storage unit 13, an authority-requiring difference identification unit 14 (function identification means), a source code storage unit 15, a difference correspondence part identification unit 16 (difference correspondence part identification means), a test item information storage unit 17 (test information acquisition means), a test selection unit 18 (test selection means), a selection result output unit 19 (output means), and an application test table storage unit 20.

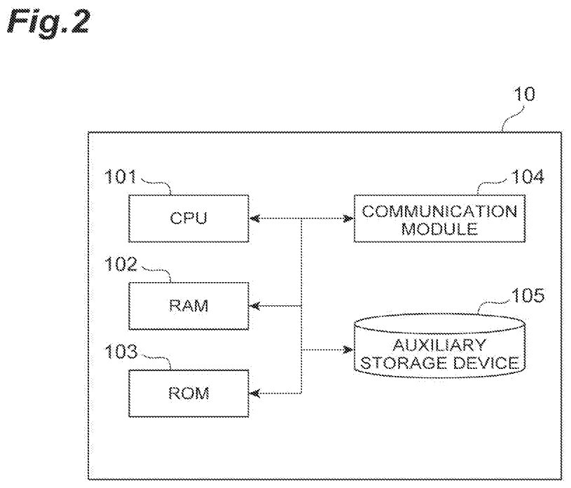

FIG. 2 is a diagram illustrating a hardware configuration of the server 10. As illustrated in FIG. 2, the server 10 is configured to include a computer including hardware such as a CPU 101, a RAM (Random Access Memory) 102 and a ROM (Read Only Memory) 103 which are main storage devices, a communication module 104 that performs communication, and an auxiliary storage device 105 such as a hard disk. Functions of the functional elements illustrated in FIG. 1 are realized by causing the elements to operate in accordance with a program or the like. The server 10 may be constituted by a computer system including a plurality of computers. The functional elements illustrated in FIG. 1 will be described below.

The hardware configuration illustrated n FIG. 2 will be described in more detail. The block diagram of FIG. 1 which is used in the above description represents blocks according to functions. These functional blocks (units) are realized in an arbitrary combination of hardware and/or software. A realization means of the functional blocks is not particularly limited. That is, the functional blocks may be realized by one device which is physically and/or logically coupled, or may be realized by two or more devices which are physically and/or logically decoupled and which are directly and/or indirectly (for example, wired and/or wireless) connected to each other.

For example, the server 10 according to the embodiment of the invention may serve as a computer that performs processes of the test selection device according to this embodiment. As described above, FIG. 2 is a diagram illustrating an example of a hardware configuration of the server 10 according to the embodiment of the invention. The server 10 may be physically configured as a computer device including the CPU 101, the memory (which includes the RAM 102 and the ROM 103 and which may be simply referred to as a memory), the auxiliary storage device 105, and a bus.

In the following description, the word “device” can be replaced with “circuit,” “device,” “unit,” or the like. The hardware configuration of the server 10 may be configured of each of the one or more devices illustrated in the drawing or may be configured not to include some devices.

The functions of the server 10 illustrated in FIG. 1 are realized by reading predetermined software (a program) to hardware such as the CPU 101 and the RAM 102, causing the CPU 101 to operate to control communication via the communication module 104 or reading and/or writing of data in the memory and the auxiliary storage device 105.

The CPU 101 operates, for example, an operating system to control the computer as a whole. The CPU 101 may be configured as a CPU (Central Processing Unit) including an interface with peripherals, a controller, a calculator, a register or the like.

The CPU 101 reads programs (program codes), software modules, or data from the auxiliary storage device 105 and/or the communication module 104 to the RAM 102 and performs various processes in accordance therewith. A program causing a computer to perform at least a part of the operations described above in the embodiment is used as the program. For example, the functions of the server 10 (for example, the OS difference information acquisition unit) illustrated in FIG. 1 may be realized by a control program which is stored in the memory and operates in the CPU 101, and the other functions may be realized in the same way. The above-mentioned processes are performed by a single CPU 101, but may be simultaneously or sequentially performed by two or more CPUs 101. The CPU 101 may be mounted as one or more chips. The program may be transmitted from a network via an electrical communication line.

The memory is a computer-readable recording medium and may include, for example, at least one of the ROM 103 (such as an EPROM (Erasable Programmable ROM) or an EEPROM (Electrically Erasable Programmable ROM)) and the RAM 102. The memory may be referred to as a register, a cache, a main memory (a main storage device), or the like.

The auxiliary storage device 105 is a computer-readable recording medium, and may include, for example, at least one of an optical disc such as a CD-ROM (Compact Disc ROM), a hard disk drive, a flexible disk, a magneto-optical disk (such as a compact disk, a digital versatile disk, or a Blue-ray (registered trademark) disk), a smart card, a flash memory (such as a card, a stick, or a key drive), a floppy (registered trademark) disk, and a magnetic strip. The auxiliary storage device 105 may be referred to as an auxiliary memory. The above-mentioned storage mediums may be, for example, a database including the memory and/or the auxiliary storage device 105, a server, or other appropriate medium.

The communication module 104 is hardware transmission/reception device) that performs communication between computers via a wired and/or wireless network and is also referred to as, for example, a network device, a network controller, a network card, or a communication module.

The units such as the CPU 101 and the memory are connected to each other via a bus for transmitting information. The bus may include a single bus or may include different buses by units.

The server 10 may include hardware such as a microprocessor, a digital signal processor (DSP), an ASIC (Application Specific Integrated Circuit), a PLD (Programmable Logic Device), and an FPGA (Field Programmable Gate Array), and some or all of the functional blocks may be realized by the hardware. For example, the CPU 101 may be mounted as at least one of these hardware elements.

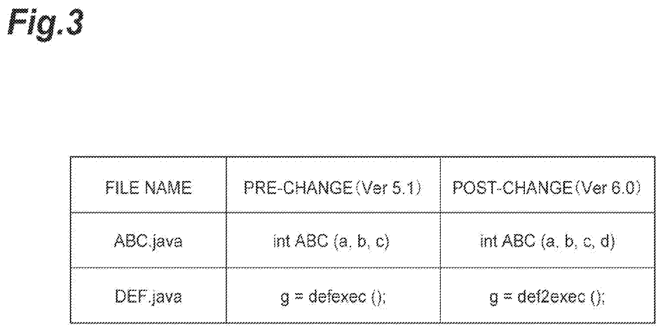

The OS difference information acquisition unit 11 is a part that acquires OS difference information. The OS difference information acquisition unit 11 acquires OS difference information from a device that stores difference information and sets the acquired. OS difference information in the OS difference information storage unit 12. The OS difference information storage unit 12 is a part that stores OS difference information. An example of information stored in the OS difference information storage unit 12 is illustrated in FIG. 3. As illustrated in FIG. 3, OS difference information including “file name,” “pre-change (Ver. 5.1),” and “post-change (Ver. 6.0)” is stored. The “file name” is a name of a file including a changed program. The “pre-change (Ver. 5.1)” represents an API (Application Programming Interface) name before changing. Here, the API refers to a protocol in which a sequence or a data format for calling and using functions of a certain program or data to be managed, or the like from an external other program is defined. It also means that the version of the OS before changing is 5.1. The “post-change (Ver. 6.0)” refers to an API name after changing. It also means that the version of the OS after changing is 6.0. In a file with a file name of “ABC.java” which is programmed by Java. (registered trademark), the information represents that a pre-change API “int ABC(a, b, c)” is changed to “int ABC(a, b, c, d)”. “int” in the “int ABC(a, b, c)” refers to a return type, and “ABC” is an API name, and “a, b, c” are parameters of the API. Accordingly, this API includes three parameters. Since parameters of the post-change API “int ABC(a, b, c, d)” are “a, b, c, d,” it means that the number of parameters has increased from 3 to 4. An API “g=defexec( )” in a file with a file name of “DEF.java” has changed to “g=def2exec( )” and the API name has changed. That is, it means that processing details of the API vary.

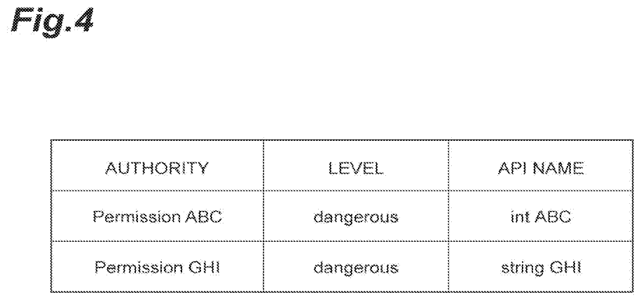

The authority-requiring API list storage unit 13 is a part that stores a list of APIs requiring authority in the OS program. Here, authority is information which has to be acquired to execute a target program and is correlated with an API or correlated with a user who executes the program. An example of information stored in the authority-requiring API list storage unit 13 is illustrated in FIG. 4. As illustrated in FIG. 4, information including “authority,” “level,” and “API name” is stored. The “authority” is authority required for executing the API. The “level” is a level of the authority. The “API name” is a name of the API. As illustrated in FIG. 4, the level of authority “Permission ABC” is “dangerous,” and this authority is required for executing the API with an API name “int ABC”. The API list is updated when the OS program is updated.

The authority-requiring difference identification unit 14 is a part that identifies a function requiring authority for execution thereof in a program indicated by the difference information. Specifically, when a request for selecting a test involved in correction of the OS program is received by a user's operation, the authority-requiring difference identification unit 14 identifies an API name in which “post-change” in information stored in the OS difference information storage unit 12 and an “API name” stored in the authority-requiring API list storage unit 13 correspond to each other. The authority-requiring difference identification unit 14 sends out the difference information corresponding to the identified API (function) and the authority corresponding to the difference information to the difference correspondence part identification unit 16.

An example in which an API requiring authority is identified from APIs indicated by the difference information using the difference information illustrated in FIG. 3 and the authority-requiring API list illustrated in FIG. 4 will be described now. The authority-requiring difference identification unit 14 acquires the difference information illustrated in FIG. 3 from the OS difference information storage unit 12 and acquires the authority-requiring API list illustrated in FIG. 4 from the authority-requiring API list storage unit 13. Subsequently, the difference correspondence part identification unit 16 identities an API in which the post-change API name in the difference information and the “API name” in the authority-requiring API list match each other. Since “ABC” is described in the “post-change” API name in FIG. 3 and the “API name” in FIG. 4, the difference correspondence part identification unit 16 identifies the API “ABC”. In this way, the authority-requiring difference identification unit 14 identifies an API requiring authority from the APIs included in the difference information.

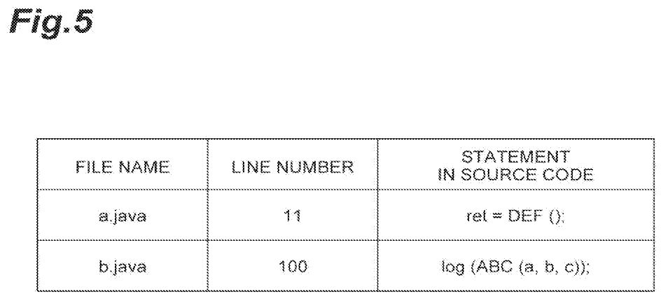

The source code storage unit 15 is a part that stores source codes of an application. An example of information stored in the source code storage unit 15 is illustrated in FIG. 5. As illustrated in FIG. 5, information including “file name,” “line number,” and “statement in source code” is stored. The “file name” is a name of a file in which source codes of an application is stored. The “line number” is a line number of a source code of the application. The “statement in source code” represents a statement described in a source code. In the example illustrated in FIG. 5, a statement “log(ABC(a, b, c))” is described in line 100 in a file with a file name “b.java”. The information illustrated in FIG. 5 represents information of some source codes for the purpose of convenience.

The difference correspondence part identification unit 16 is a part that identifies a part (an involved part) corresponding to a program of difference information in an application program. The difference correspondence part identification unit 16 acquires difference information and authority of an API indicated by the difference information from the authority-requiring difference identification unit 14. Subsequently, the difference correspondence part identification unit 16 searches the source code storage unit 15 and identifies a part (a file name, a line number) of a statement including the pre-change API in the difference information.

For example, it is assumed that the difference correspondence part identification unit 16 acquires difference information of the API “ABC” for which authority is owned by itself from the authority-requiring difference identification unit 14. In this case, the difference correspondence part identification unit 16 identifies the file name and the line number of the source code which uses the API “ABC” with reference to the source code storage unit 15. When the information illustrated in FIG. 5 is stored in the source code storage unit 15, it means that the statement including “ABC” is described in the line number 100 in the file with a file name “b.java” and thus the difference correspondence part identification unit 16 identifies the line number 100 of the file name “b.java”. This means that a file name and a line number of a program of an application using an API requiring authority for execution of the APT are identified as a changed API in the OS program. That is, the difference correspondence part identification unit 16 identities a part which is considered to be involved in the OS program.

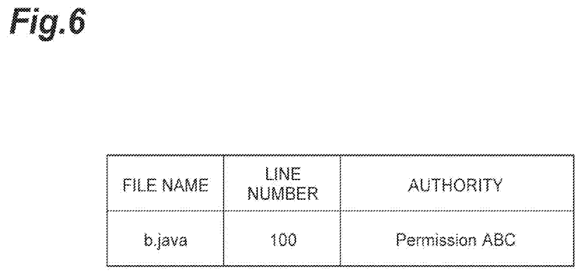

The difference correspondence part identification unit 16 generates involved part information which is information based on the identification result. Specifically, the difference correspondence part identification unit 16 generates involved part information including the identified file name, the identified line number, and the authority (authority corresponding to the difference information) acquired from the authority-requiring difference identification unit 14. An example of information which is generated by the difference correspondence part identification unit 16 is illustrated in FIG. 6. As illustrated in FIG. 6, the difference correspondence part identification unit 16 generates information including the line number, the file name corresponding to the line number, and the authority for execution of the API “ABC”. The information generated by the difference correspondence part identification unit 16 is sent out to the test selection unit 18.

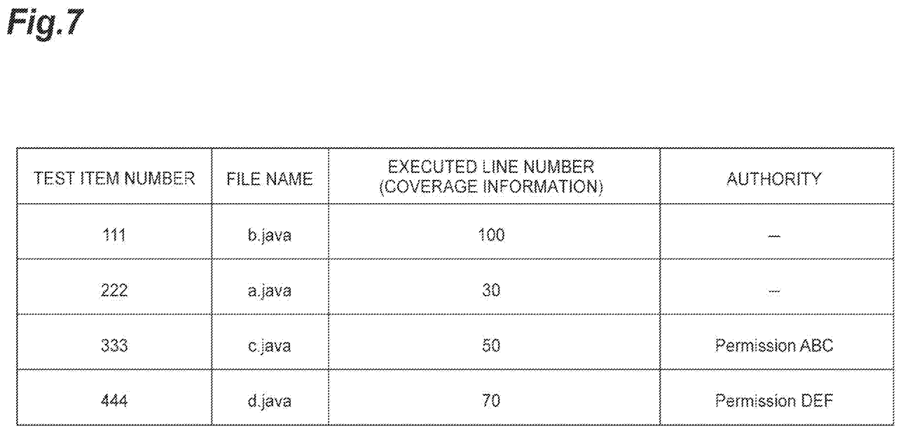

The test item information storage unit 17 is a part that stores test item information (test information) which is information of a test including a part which is executed in the test of the application for each test. An example of information stored in the test item information storage unit 17 is illustrated in FIG. 7. As illustrated in FIG. 7, information including “test item number,” “file name,” “executed line number (coverage information),” and “authority” is stored. The “test item number” is a number given to each test and is information for identifying the test. The “file name” is a name of a file constituting an application program to be tested. The “executed line number (coverage information)” represents a line number (an execution part) in a program file of the application program which is executed in the test.

This line number is a line number which is acquired by executing tests using a program (for example, a coverage tool such as JaCoCo of open source software) that measures a part of an application executed in a test. The “authority” represents authority which is required for execution of the part of the line number executed in the application to be tested. By causing a user to input information in which a line number (an executed line number) acquired by executing a test using a device (for example, the server 10) that tests an application, a test item number, and authority corresponding to the test item number are correlated, the test item information to be stored in the test item information storage unit 17 is stored in the test item information storage unit 17. In this way, the test item information storage unit 17 acquires and stores the test item information. The information illustrated in FIG. 7 represents information of some test items for the purpose of convenience.

The test selection unit 18 is a part that selects a test corresponding to the involved part identified by the difference correspondence part identification unit 16. The test selection unit 18 acquires involved part information from the difference correspondence part identification unit 16. When the involved part information is acquired, the test selection unit 18 selects a test on the basis of the involved part information.

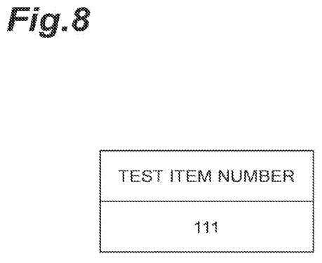

Specifically, the test selection unit 18 selects a test item number corresponding to a file name and a line number included in the involved part information. For example, when the involved part information illustrated in FIG. 6 is acquired, the test selection unit 18 selects a test item number in which the file name is “b.java” and the executed line number is “100” in the test item information stored in the test item information storage unit 17 and illustrated in FIG. 7 on the basis of the involved part information indicating that the file name is “b.java” and the line number “100”. As a result, the test selection unit 18 selects the test item number “111” as illustrated in FIG. 8. In this way, the test selection unit 18 selects a test corresponding to the involved part which is identified by the difference correspondence part identification unit 16.

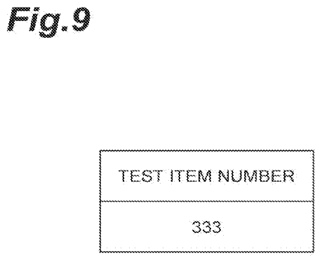

The test selection unit 18 selects a test item number corresponding to the file name and the line number included in the involved part information and also selects a test item number corresponding to the authority included in the involved part information, as described above. For example, the test selection unit 18 selects a test in which the authority is “Permission ABC” in the test item information stored in the test item information storage unit 17 and illustrated in FIG. 7 on the basis of the involved part information in which the authority is “Permission ABC” and which are illustrated in FIG. 6. As a result, the test selection unit 18 selects a test item number “333” as illustrated in FIG. 9. In this way, the test selection unit 18 additionally selects a test in which authority in which the authority included in the test item information corresponds to the authority identified by the authority-requiring difference identification unit 14 is required for execution of the test.

When a test is selected and a test item number is selected as described above, the test selection unit 18 sends the test item number to the selection result output unit 19. When the test item corresponding to the file name and the line number included in the involved part information cannot be selected (when the test item number corresponding to the file name and the line number included in the involved part information is not present), the test selection unit 18 sends the file name and the line number included in the involved part information to the selection result output unit 19.

The selection result output unit 19 is a part that outputs the test selected by the test selection unit 18. Specifically, when a test item number is acquired from the test selection unit 18, the selection result output unit 19 sets the test item number in the application test table storage unit 20. When a file name and a line number included in the involved part information have been acquired from the test selection unit 18, that is, when a test item corresponding to the file name and the line number is not selected, the selection result output unit 19 sets information indicating that the number of test items corresponding to the file name and the line number is zero along with the file name and the line number in the application test table storage unit 20. The selection result output unit 19 may transmit test item number information including the acquired test item number to another device.

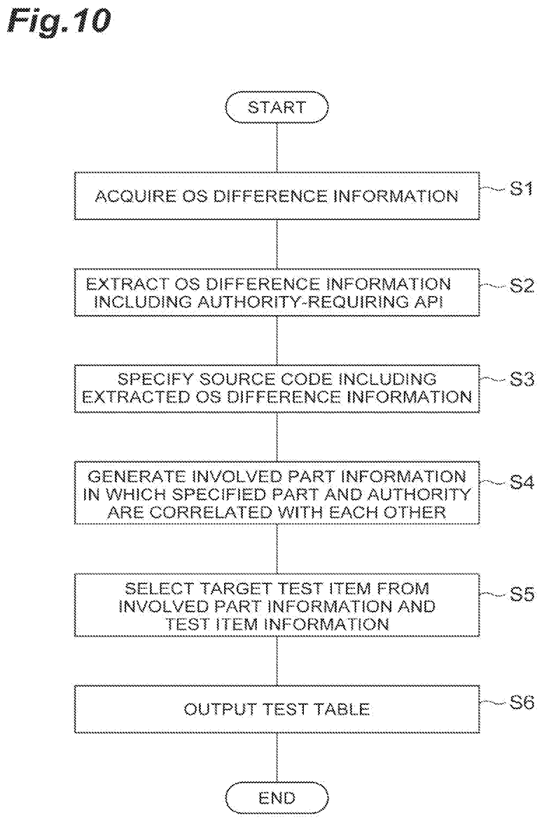

A processing routine which is performed by the server 10 will be described below with reference to the flowchart illustrated in FIG. 10. The flowchart illustrated in FIG. 10 is a diagram illustrating a processing routine of selecting a test involved in an OS difference.

The server 10 acquires OS difference information from a device that stores a source program of an OS program and stores difference information indicating an updated state of the source program, and sets the acquired OS difference information in the OS difference information storage unit 12 (Step S1). Subsequently, the authority-requiring difference identification unit 14 combines the OS difference information stored in the OS difference information storage unit 12 with an authority-requiring API list stored in the authority-requiring API list storage unit 13 and extracts OS difference information including an authority-requiring API (Step S2). Subsequently, the difference correspondence part identification unit 16 identifies a part (a file name and a line number) including the API of the extracted OS difference information with reference to the source code storage unit 15 (Step S3). The difference correspondence part identification unit 16 generates involved part information in which the identified part is correlated with authority (Step S4). The test selection unit 18 selects a target test from the involved part information and the test item information (Step 5). The selection result output unit 19 stores information of the test selected by the test selection unit 18 in the application test table storage unit 20 (Step S6).

In the above-mentioned embodiment, the difference correspondence part identification unit 16 generates the involved part information using the OS difference information including authority which is identified by the authority-requiring difference identification unit 14, but all OS difference information may be used regardless of whether the API is stored in the authority-requiring API list storage unit 13. That is, the difference correspondence part identification unit 16 may identify a part (a file name and a line number) of an application program which uses the API indicated by the OS difference information stored in the OS difference information storage unit 12 (the OS difference information acquired by the OS difference information acquisition unit 11) with reference to the source code storage unit 15.

In the above-mentioned embodiment, the test item information storage unit 17 stores test item information in advance, but the test item information may be acquired from another device that stores the test item information. The test selection unit 18 selects a test from the test item information stored in the test item information storage unit 17, but may select a test indicated by test item information by notifying another device that stores the test item information of a file name and a line number included in the involved part information and acquiring the test item information corresponding to the file name and the line number.

In the above-mentioned embodiment, the test selection device is embodied by the server 10, but the test selection device may be embodied by another information processing device. For example, the test selection device may be embodied by a stand-alone device such as a personal computer.

Operations and effects of the invention will be described below. The OS difference information acquisition unit 11 acquires difference information indicating information of a changed program in an OS program. The difference correspondence part identification unit 16 identifies an involved part corresponding to the difference information in an application program. The test selection unit 18 selects a test corresponding to the involved part.

Accordingly, since a part of an application program corresponding to the difference part of the OS is identified and a test for the involved part is selected, it is possible to select only a test involved in the difference of the OS. In this way, when correction of a program is carried out, it is possible to appropriately select a test.

The test selection unit 18 selects a test of an involved part on the basis of test item information stored in the test item information storage unit 17. In this case, since a test is selected using information indicating a test execution part, it is possible to appropriately select a test involved in the difference information.

The authority-requiring difference identification unit 14 identifies a program requiring authority for execution thereof in a program indicated by difference information and the difference correspondence part identification unit 16 identifies a part of an application corresponding to the program identified by the authority-requiring difference identification unit 14. In this case, since a test corresponding to the program requiring authority in the difference part of the OS is selected, it is possible to narrow a selection range to tests requiring authority and to select a test.

The test item information may additionally include information indicating authority required for an application which is executed in each test, and the test selection unit 18 additionally selects a test in which the authority included in the acquired test item information corresponds to authority identified by the authority-requiring difference identification unit 14. In this case, since a test for an application program requiring authority required for executing the program indicated by the difference information is selected, it is possible to comprehensively select tests with authorities involved in correction.

When a file name and a line number included in involved part information are acquired from the test selection unit 18, the selection result output unit 19 sets information indicating that the number of test items corresponding to the file name and the line number is zero along with the file name and the line number in the application test table storage unit 20. In this case, since a message indicating that there is an involved part but a test for an application is not selected is output, it is possible to notify that there is a likelihood that leakage of a test item will occur. It may also be possible to notify that there is a likelihood that leakage of a test item corresponding to a part of an application program involved in change of an API which cannot be executed without authority will occur.

While the invention has been described above in detail, it is apparent to those skilled in the art that the invention is not limited to the embodiment described in this specification. The invention can be modified and altered in various forms without departing from the gist and scope of the invention defined by description in the appended claims. Accordingly, description in this specification is for exemplary explanation, and does not have any restrictive meaning for the invention.

Transmission of information is not limited to the aspects/embodiments described in this specification, but may be performed using other methods. For example, transmission of information may be performed by physical layer signaling (such as DCI (Downlink Control Information) or UCI (Uplink Control Information)), upper layer signaling (such as RRC (Radio Resource Control) signaling, MAC (Medium Access Control) signaling, or notification information (such as an MIB (Master Information Block) or an SIB (System Information Block)), other signaling, or a combination thereof. The RRC signaling may be referred to as an RRC message and may be, for example, an RRC connection setup message or an RRC connection reconfiguration message.

The aspects/embodiments described in this specification may be applied to systems employing LIE (Long Term Evolution), LTE-A (LIT-Advanced), SUPER 3Q IMT-Advanced, 4G, 5G, FRA (Future Radio Access), W-CDMA (registered trademark), GSM (registered trademark), CDMA2000, UMB (Ultra Mobile Broadband), IEEE 802.11 (Wi-Fi), IEEE 802.16 (WIMAX), IEEE 802.20, UWB (Ultra-WideBand), Bluetooth (registered trademark), or other appropriate systems and/or next-generation systems to which these systems are extended on the basis thereof.

The order of the processing sequences, the sequences, the flowcharts, and the like of the aspects/embodiments described above in this specification may be changed as long as it does not cause any inconsistencies. For example, in the methods described in this specification, various steps are described as elements in an exemplary order but the methods are not limited to the described order.

Information or the like can be output from an upper layer (or a lower layer) to a lower layer (or an upper layer). Information or the like may be input and output via a plurality of network nodes.

The input or output information or the like may be stored in a specific place (for example, a memory) or may be managed in a management table. The input or output information or the like may be overwritten, updated, or added to. The output information or the like may be deleted. The input information or the like may be transmitted to another device.

Determination may be performed using a value (0 or 1) expressed by one bit, may be performed using a Boolean value (true or false), or may be performed by comparison of numerical values (for example, comparison with a predetermined value).

The aspects described in this specification may be used alone, may be used in combination, or may be switched during implementation thereof. Transmission of predetermined information (for example, transmission of “X”) is not limited to explicit transmission, and may be performed by implicit transmission (for example, the predetermined information is not transmitted).

Regardless of whether it is called software, firmware, middleware, microcode, hardware description language, or another name, software can be widely analyzed to refer to commands, a command set, codes, code segments, program codes, a program, a sub program, a software module, an application, a software application, a software package, a routine, a sub routine, an object, an executable file, an execution thread, an order, a function, or the like.

Software, a command, and the like may be transmitted and received via a transmission medium. For example, when software is transmitted from a web site, a server, or another remote source using wired technology such as a coaxial cable, an optical fiber cable, a twisted-pair wire, or a digital subscriber line (DSL) and/or wireless technology such as infrared rays, radio waves, or microwaves, the wired technology and/or the wireless technology is included in the definition of the transmission medium.

Information, signals, and the like described in this specification may be expressed using one of various different techniques. For example, data, an instruction, a command, information, a signal, a bit, a symbol, and a chip which can be mentioned in the overall description may be expressed by a voltage, a current, an electromagnetic wave, a magnetic field or magnetic particles, a photo field or photons, or an arbitrary combination thereof.

The terms described in this specification and/or the terms required for understanding this specification may be substituted with terms having the same or similar meanings.

The terms “system” and “network” are used interchangeably in this specification.

Information, parameters, and the like described in this specification may be expressed as absolute values, may be expressed by values relative to a predetermined value, or may be expressed by other corresponding information. For example, radio resources may be indicated by indices.

Names which are used for the parameters are not restrictive in any respect. Expressions or the like using the parameters may be different from the expressions which are explicitly disclosed in this specification. Since various channels (for example, a PUCCH or a PDCCH) and information elements (for example, a TPC) can be distinguished by appropriate names, the various names given to various channels and information elements are not restrictive in any respect.

The expression “connected” or any modification thereof refers to any direct or indirect connection between two or more elements and can include a case in which one or more intermediate elements are present between two elements “connected” to each other. The connection between elements may be physical, may be logical, or may be a combination thereof. In this specification, two elements can be considered to be “connected” to each other using one or more electric wires, cables, and/or printed electric connection or using electromagnetic energy such as electromagnetic energy having wavelengths in a radio frequency area, a microwave area, and a light (both visible light and invisible light) area as non-restrictive and non-comprehensive examples.

The expression “on the basis of” as used in this specification does not mean “on the basis of only” unless otherwise described. In other words, the expression “on the basis of” means both “on the basis of only” and “on the basis of at least”.

Any reference to elements having names such as “first” and “second” which are used in this specification does not generally limit amounts or an order of the elements. The terms can be conveniently used to distinguish two or more elements in this specification. Accordingly, reference to first and second elements does not mean that only two elements are employed or that the first element has to precede the second element in any form.

“Means” in the configuration of each device may be replaced with “unit,” “circuit,” “device,” or the like.

When the terms “include,” “including,” and modifications thereof are used in this specification or the appended claims, the terms are intended to have a comprehensive meaning similar to the term “comprise”. The term “or” which is used in this specification or the claims is not intended to mean an exclusive logical sum.

In this specification, a device includes a plurality of devices, except for cases in which it is apparent from the context or technology that there is only one device.

In the whole disclosure, a singular term can refer to both singular and plural referents unless it is clearly indicated otherwise.

### REFERENCE SIGNS LIST

10 . . . server, 11 . . . OS difference information acquisition unit, 12 . . . OS difference information storage unit, 13 . . . authority-requiring API list storage unit, 14 . . . authority-requiring difference identification unit, 15 . . . source code storage unit, 16 . . . difference correspondence part identification unit, 17 . . . test item information storage unit, 18 . . . test selection unit, 19 . . . selection result output unit, 20 . . . application test table storage unit, 101 . . . CPU, 102 . . . RAM, 103 . . . ROM, 104 . . . communication module, 105 . . . auxiliary storage device.

1-5. (canceled)

6. A test selection device comprising:
circuitry configured to acquire difference information indicating a changed part in a first program,
identify an involved part indicated by the difference information in a second program using functions based on the first program, and
select a test for the second program corresponding to the involved part.

7. The test selection device according to claim 6, wherein
the circuitry is configured to
acquire test information including an execution part which is executed in a test, and
select a test corresponding to the involved part on the basis of the test information.

8. The test selection device according to claim 6, wherein
the circuitry is configured to
identify a function based on the difference information requiring authority for execution on the basis of the difference information, and
identify an involved part of the second program corresponding to the function.

9. The test selection device according to claim 8, wherein
the circuitry is configured to select additionally a test in which authority corresponding to the authority for the function is required for execution of the test.

10. The test selection device according to claim 6, wherein
the circuitry is configured to output a message indicating that a test for the second program corresponding to the involved part has not been selected when the test for the second program has not been selected.
